(19) United States
(12) Patent Application Publication
(10) Pub. No.: US 2026/0366457 A1
(43) Pub. Date: Nov. 19, 2026

(54) METHANE-PYROLYSIS BASED GAS TURBINE SYSTEM AND METHOD

(71) Applicant: Nuovo Pignone Tecnologie - S.r.l., Florence (IT)

(72) Inventors: Manjush GANIGER, Florence (IT); Uday MEDURI, Florence (IT); Vidyasagar Ramalingam RENGASAMY, Florence (IT)

(21) Appl. No.: 19/476,355

(22) PCT Filed: Mar. 25, 2024
(86) PCT No.: PCT/EP2024/025125

§ 371 Date: Oct. 17, 2025

(30) Foreign Application Priority Data
Mar. 31, 2023 (IT) 102023000006369

(51) Int. Cl. F02C 3/22; C01B 3/24; F01K 23/06

(52) U.S. Cl. CPC F02C 3/22; F01K 23/067; C01B 3/24; C01B 2203/0811; C01B 2203/84; F05D 2260/213

(57) ABSTRACT

The power generation system comprises a pyrolysis unit with a pyrolysis re actor adapted to generate hydrogen from pyrolysis of hydrocarbon, in particular natural gas, and a heat generator adapted to provide heat to the pyrolysis reactor. A gas turbine engine is further provided, which is supplied with hydrogen generated by the pyrolysis unit. A waste heat recovery arrangement recovers waste heat from flue gas of the gas turbine engine and deliver recovered waste heat to the pyrolysis unit.

### TECHNICAL FIELD

Disclosed herein is an internal combustion engine system, in particular a gas turbine system, using a hydrogen-rich fuel and a method for power generation using a gas turbine fueled with a hydrogen-rich fuel.

### BACKGROUND ART

Climate changes caused by the power production processes are becoming a great concern in recent times. Fossil fuels are still largely used for the production of mechanical and electric power through thermodynamic cycles. The combustion of fossil fuels, however, generates large amounts of carbon dioxide, a greenhouse gas considered responsible for global warming.

In recent years, in an attempt to reduce emission of greenhouse gas and mitigate climate changes caused by anthropic activities, hydrogen has been taken into consideration as an alternative fuel, to replace fossil fuels, since its energetic use does not lead to direct carbon dioxide emissions.

Several techniques for the production of hydrogen are currently investigated. Among others, electrolysis and steam reforming of hydrocarbons, such as methane, are possible options for the generation of hydrogen. An additional technique for hydrogen production with low greenhouse gas emission is the decomposition of hydrocarbons, in particular natural gas mainly consisting of methane (CH₄), into carbon and hydrogen according to the endothermic reaction:

CₓH_{y}——>xC+(y/2)H₂

wherein the resulting carbon is in a solid state. The decomposition reaction is usually referred to as “pyrolysis”. The resulting hydrogen can be used to supply fuel cells, or as a gaseous fuel for internal combustion engines, such as gas turbine engines, or reciprocating engines. The solid carbon generated by pyrolysis of the hydrocarbons is a valuable by-product which can be used in several industrial fields.

Generating hydrogen is expensive and energy consuming. For instance, production of hydrogen by pyrolysis requires considerable amount of thermal energy. It is therefore important that the power generation process using hydrogen be efficient. Improving the efficiency of power generation systems using hydrogen as a fuel would therefore be useful and welcomed in the art.

### SUMMARY

According to a first aspect, disclosed herein is a power generation system using an internal combustion engine, such as a gas turbine engine. As used herein, the term “internal combustion engine” indicates a machine wherein combustion of a fuel in the interior of the machine generates heat which is partly converted into mechanical power by the engine. As such, the term internal combustion engine includes not only reciprocating combustion engines, but also and in particular gas turbine engines.

In embodiments disclosed herein, the system comprises a pyrolysis unit comprising a pyrolysis reactor adapted to generate hydrogen from pyrolysis of hydrocarbon, in particular natural gas, and a heat generator adapted to provide heat to the pyrolysis reactor. The system further includes an internal combustion engine, in particular a gas turbine engine adapted to be supplied with hydrogen generated by the pyrolysis unit. A waste heat recovery arrangement is further provided, which is adapted to recover waste heat from flue gas of the internal combustion engine and deliver recovered waste heat to the pyrolysis unit. Waste heat recovered from the flue gas of the internal combustion engine reduces the amount of power required for the pyrolysis of the hydrocarbon fuel.

Further features and embodiments of the system according to the present disclosure are outlined below and set forth in the appended claims.

According to a further aspect, disclosed herein is a method comprising a step of processing a stream of hydrocarbon in a pyrolysis unit and generating hydrogen and solid carbon therefrom; wherein the pyrolysis unit comprises a pyrolysis reactor and a heat generator. The method further comprises a step of fueling an internal combustion engine, such as a gas turbine engine, with the hydrogen and generating mechanical power therewith. The method also comprises the steps of recovering waste heat from flue gas of the internal combustion engine; and suppling recovered waste heat to the pyrolysis unit.

Further advantageous features and embodiments of the method according to the present disclosure are outlined below and set forth in the appended claims

### BRIEF DESCRIPTION OF THE DRAWINGS Reference is now made briefly to the accompanying drawings, in which:

FIG. 1 is a schematic of a power generation system of the present disclosure in one embodiment;

FIG. 2 is a schematic of a power generation system of the present disclosure in a further embodiment;

FIG. 3 is a schematic of a power generation system of the present disclosure in a yet further embodiment; and

FIG. 4 illustrates a flowchart summarizing an embodiment of a method according to the present disclosure.

### DETAILED DESCRIPTION

In the present description reference is specifically made to the use of natural gas and/or methane. However, it shall be understood that in other embodiments the source of carbon and hydrogen fed to the pyrolysis reactor can be a different hydrocarbon or hydrocarbon mixture. The term “hydrocarbon” as used herein may include also a mixture or blend of different hydrocarbons.

In the present description, reference will be made specifically to a gas turbine engine, but a system using a different internal combustion engine, such as a reciprocating combustion engine, is not ruled out.

To improve the efficiency of a power generation system and reduce carbon dioxide emissions thereof, the system comprises a gas turbine engine and a hydrocarbon pyrolysis unit. A hydrocarbon feed, for instance natural gas, is at least partly converted by the pyrolysis unit into hydrogen and solid carbon. The gas turbine engine is fueled with hydrogen, or a mixture of hydrogen and non-converted hydrocarbon, to generate power. Waste heat from the gas turbine engine is at least partly exploited in the pyrolysis unit to reduce the amount of thermal power needed for the pyrolysis process.

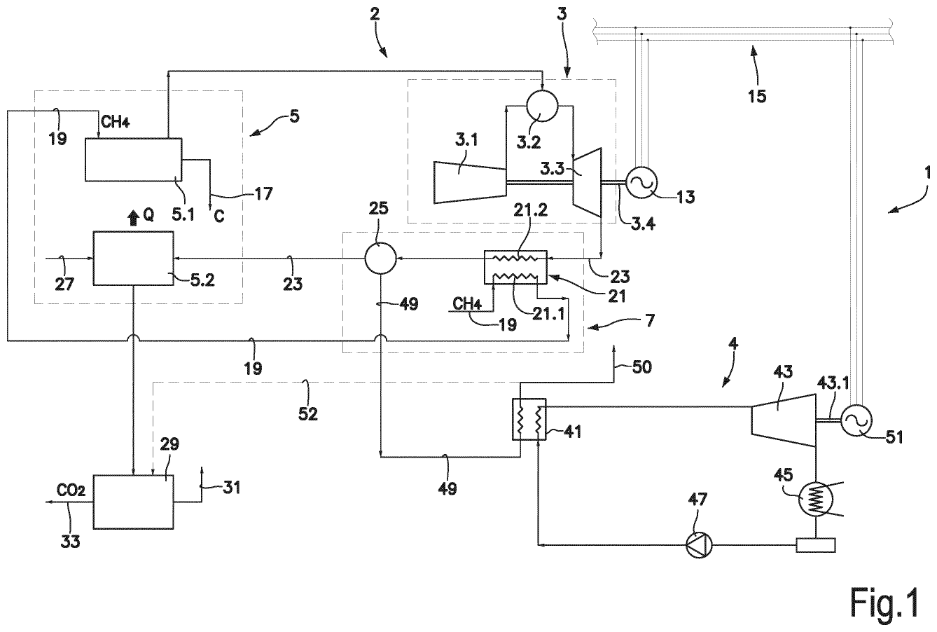

Turning now to the drawings, FIG. 1 illustrates a first embodiment of a power generation system according to the present disclosure. The system is labeled 1 as a whole and includes a top thermodynamic cycle 2, i.e. a high-temperature thermodynamic cycle and a bottom thermodynamic cycle 4, i.e. a low-temperature thermodynamic cycle. In some embodiments the bottom thermodynamic cycle 4 can be omitted. The terms “high-temperature” and “low-temperature” are relative terms indicating that the top thermodynamic cycle operates at a temperature higher than the bottom thermodynamic cycle.

The top thermodynamic cycle 2 can include a Bryton cycle. In embodiments, the top thermodynamic cycle 2 includes a gas turbine engine 3, a pyrolysis unit 5, and a waste heat recover arrangement 7.

The pyrolysis unit 5 can include a pyrolysis reactor 5.1 and a heat generator. In some instances the heat generator comprises a furnace 5.2. The gas turbine engine 3 includes a compressor section 3.1, a combustor 3.2 and a turbine section 3.3. The gas turbine engine 3 further includes an output shaft 3.4 drivingly coupled to a load driven by power generated by the gas turbine engine 3. In the embodiment of FIG. 1 the load includes an electric generator 13, which converts mechanical power generated by the gas turbine engine 3 into electric power. The electric generator 13 can be electrically coupled to an electric power distribution grid 15. In FIG. 1 the gas turbine engine 3 is schematically represented as a one-shaft turbine. It shall however be understood that a different gas turbine engine can be used, such as a gas turbine engine with two or more shafts. The gas turbine engine can be a heavy-duty gas turbine engine or an aeroderivative gas turbine engine, for instance.

The pyrolysis unit 1 is adapted to convert at least in part a fossil fuel into hydrogen H₂ and solid carbon C. The hydrogen is used to fuel the gas turbine engine 3, while solid carbon C is collected at 17 and can be used as a valuable by-product of the power generation process performed by the power generation system 1.

In the present description reference will be made specifically to natural gas, and more specifically to methane (CH₄) as fossil fuel for the power generator system 1. It shall however be understood that other hydrocarbons or hydrocarbon blends can be used instead of natural gas or in combination therewith. Natural gas is particularly useful, since the gas turbine engine 3 can be fueled with a blend of natural gas and hydrogen generated by partial pyrolysis of natural gas. The decomposition of natural gas in the pyrolysis unit 5 can therefore be only partial.

The natural gas is fed to the pyrolysis reactor 5.1 through a natural gas feed line 19, which extends through a cold side 21.1 of a first heat exchanger 21 of the waste heat recovery arrangement 7. The first heat exchanger 21 features a first waste heat recovery heat exchanger adapted to recover waste heat from flue gas of the gas turbine engine 3. The flue gas from the gas turbine engine 3 flows along a flue gas flow path 23 which extends through a hot side 21.2 of the first heat exchanger 21, such that high-temperature waste heat contained in the flue gas is recovered in the first heat exchanger 21 and used to heat the natural gas fed through the natural gas feed line 19 to the pyrolysis reactor 5.1.

In some embodiments which include a bottom thermodynamic cycle 4, a splitter 25 is positioned along the flue gas flow path 23 downstream of the first heat exchanger 21. The flue gas stream is split in splitter 25 and partly deviated toward the bottom thermodynamic cycle 4 to deliver waste heat thereto. Downstream of the splitter 25 the flue gas flow path 23 extends to the furnace 5.2. The flue gas from gas turbine engine 3 contains residual oxygen (O₂) which is used as an oxidant in the furnace 5.2. Fuel is delivered to the furnace through a fuel inlet 27. The furnace can be fueled with natural gas or another fuel.

The combustion gas from the furnace 5.2 contains carbon dioxide (CO₂) and can be treated in a carbon dioxide capture unit 29 to remove carbon dioxide at least partly from the combustion gas. The CO₂-lean combustion gas, i.e., combustion gas wherefrom CO₂ has been removed fully or in part, is released in the environment through a stack 31. Compressed carbon dioxide is delivered through a duct 33 to a storage device, a pipeline, not shown, or the like.

In the embodiment of FIG. 1 the bottom thermodynamic cycle 4 can comprise a steam Rankine cycle, an organic Rankine cycle (ORC), or the like. In the schematic of FIG. 1 the bottom thermodynamic cycle 4 includes a process fluid heater 41, an expander, e.g. a steam turbine 43, a condenser 45 and a pump 47. In the process fluid heater 41 the flue gas diverted in splitter 25 and flowing through a diverting line 49 transfers low-temperature waste heat to the process fluid of the bottom thermodynamic cycle 4. If the bottom thermodynamic cycle is a steam Rankine cycle, the process fluid is water which is vaporized and the steam generated in the heater 41 expands in the steam turbine 43. A turbine shaft 43.1 drivingly couples the steam turbine 43 to a load. In the embodiment of FIG. 1 the load comprises an electric generator 51, which is electrically connected to the electric power distribution grid 15. In the schematic of FIG. 1 the bottom cycle is represented as a simplified steam Rankine cycle. It shall be understood that more complex bottom cycles can be used, for instance including regenerative cycles, for instance.

The flue gas from the heater 41 can be discharged in the atmosphere through a stack 50. In other embodiments, the flue gas from the heater 41 can be processed thorough the carbon capture unit 29 before being released in the environment. This can be advantageous, e.g. if the fuel used in the gas turbine engine 3 includes a blend of hydrogen and hydrocarbons.

The power generation system 1 described so far operates as follows. Natural gas is fed through the first heat exchanger 21 and is pre-heated by waste heat from the gas turbine engine 3. The pre-heated natural gas is delivered to the pyrolysis reactor 5.1. Since the natural gas to be decomposed is pre-heated, less thermal power is required from the furnace 5.2 to activate and support the decomposition reaction which generates hydrogen and solid carbon in the pyrolysis reactor 5.1.

The hydrogen generated by decomposition of natural gas (mainly methane), is delivered to the gas turbine engine 3 and burned therein in the combustor 3.2 where hydrogen and compressed air are mixed and combusted. In some embodiments, as mentioned above, the natural gas pyrolysis can be incomplete, i.e. not the entire natural gas flowrate is converted into solid carbon and hydrogen. The remaining natural gas is fed to the gas turbine engine 3 in a mixture with hydrogen.

Pyrolysis of the natural gas removes carbon from the gas fueling the gas turbine engine, such that the flue gas from the gas turbine engine 3 does not contain carbon dioxide. If the natural gas is only party decomposed by pyrolysis, a beneficial effect of a reduction of carbon dioxide content in the flue gas is still achieved. In substance, the carbon contained in the natural gas is (at least partly) removed in solid form (at 17) and can be used as a valuable component in other industrial processes, rather than released in the atmosphere in the form of carbon dioxide following oxidation in the combustor 3.2.

The thermal energy (in the form of waste heat) contained in the flue gas from the gas turbine engine 3 is used to pre-heat the natural gas in the natural gas feed line 19, as mentioned.

The flue gas exiting the first heat exchanger 21 is still hot enough to provide thermal energy to the bottom thermodynamic cycle 4, where lower temperature waste heat is partly converted in additional mechanical power available on the output shaft 43.1 of the expander or steam turbine 43.

The flue gas which is not diverted to the bottom thermodynamic cycle 4 at the splitter 25 introduces thermal energy in the furnace 5.2.

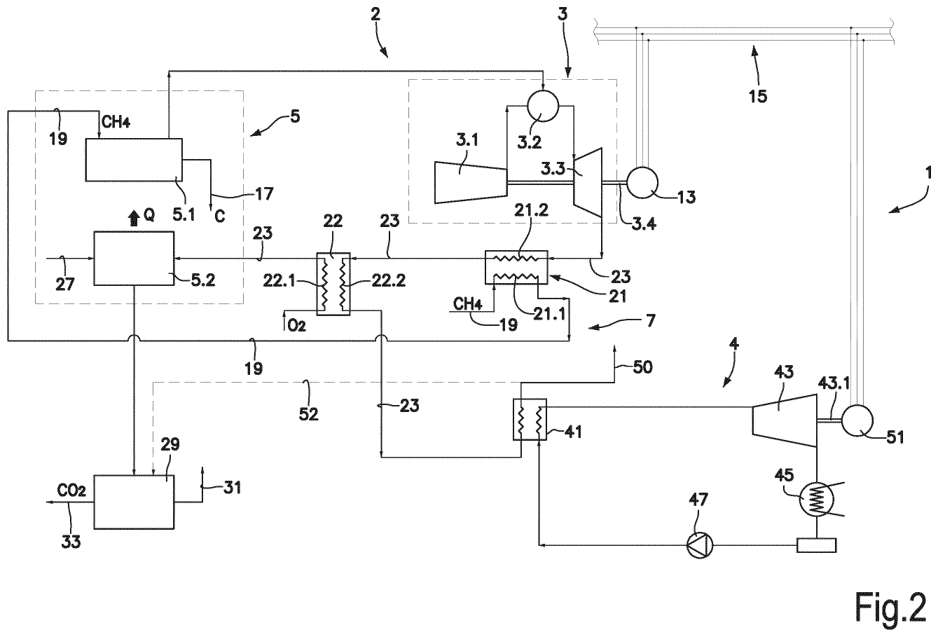

With continuing reference to FIG. 1, a further embodiment of a power generation system according to the present disclosure is shown in FIG. 2, where the same reference numbers of FIG. 1 are used to designate the same or equivalent parts, elements or components of the power generation system which will not be described in detail again.

The embodiment of FIG. 2 differs from the embodiment of FIG. 1 mainly in that no splitter 25 is provided along the flue gas flow path 23 and that the latter does not extend to the furnace 5.2. Differently from FIG. 1, in FIG. 2 the entire flue gas stream flows through the hot side of the process fluid heater 41 and is released at stack 50, or processed through the carbon dioxide capture unit 29.

In the embodiment of FIG. 2 a second heat exchanger 22 is provided along the flue gas flow path 23. The second heat exchanger 22 features a second waste heat recovery heat exchanger, adapted to recover waste heat from the flue gas of the gas turbine engine 3. Specifically, the second heat exchanger 22 includes a hot side 22.2 through which the flue gas flows in heat exchange with a cold side 22.1 of the second heat exchanger 22. An oxidant flow for the furnace 5.2 flows through the cold side 22.1 and is pre-heated by low-temperature waste heat released by the flue gas flowing through the hot side 22.2 of the second heat exchanger 22.

Thus, similarly to the embodiment of FIG. 1, also in the embodiment of FIG. 2 part of the waste heat contained in the flue gas from the gas turbine engine 3 is delivered to the furnace 5.2 to reduce the amount of thermal energy demand from the furnace 5.2. However, while in FIG. 1 the waste heat is contained in the residual flue gas flowing into the furnace 5.2, in the embodiment of FIG. 2, the full flue gas flow is caused to flow through the process gas heater 41 to heat or vaporize the process fluid of the bottom thermodynamic cycle 4, after a fraction of the thermal energy contained therein has been removed in the second heat exchanger 22.

In the embodiment of FIG. 2 the first heat exchanger 21 and the second heat exchanger 22 are arranged in series with the second heat exchanger 22 being downstream the first heat exchanger 21. A reversed arrangement is not excluded, wherein the first heat exchanger 21 is arranged downstream of the second heat exchanger 22 with respect of the direction of flow of the flue gas.

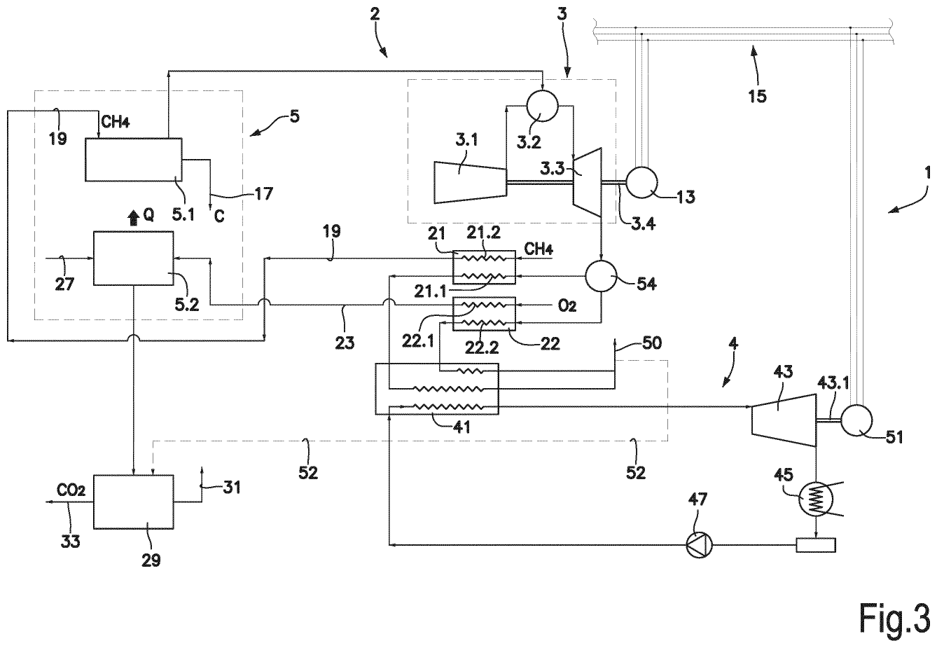

With continuing reference to FIGS. 1 and 2, a further embodiment of the power generation system 1 is shown in FIG. 3, in which the same reference numbers of FIGS. 1 and 2 and are used to designate the same or equivalent parts, elements, or components of the power generation system, which will not be described in detail again

The embodiment of FIG. 3 differs from the embodiment of FIG. 2 mainly in that the first waste heat recovery heat exchanger 21 and the second waste heat recovery heat exchanger 22 are arranged in parallel rather than in series. Thus, waste heat is recovered at substantially the same temperature in the first heat exchanger 21 and in the second heat exchanger 22, to pre-heat the natural gas and the oxidant, respectively. The flue gas flow from the gas turbine engine 3 is split in a splitter 54 into a first flow directed through the first heat exchanger 21 and a second flow directed through the second heat exchanger 23.

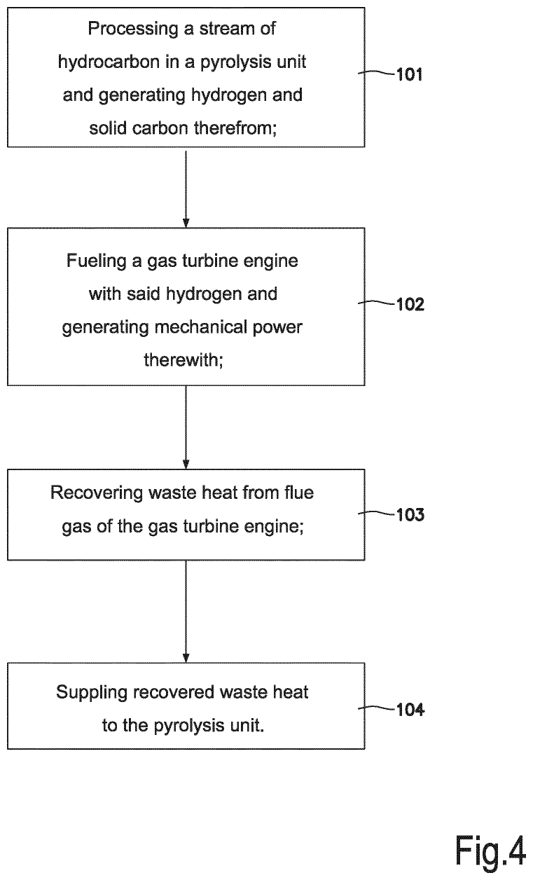

FIG. 4 shows a flowchart summarizing the method for generating power with the system described above. The method includes: a first step (101) of processing a stream of hydrocarbon in a pyrolysis unit and generating hydrogen and solid carbon therefrom; a second step (102) of fueling the gas turbine engine with said hydrogen and generating mechanical power therewith; a third step (103) of recovering waste heat from flue gas of the gas turbine engine; and a fourth step (104) of suppling recovered waste heat to the pyrolysis unit.

In the embodiments illustrated above, if the pyrolysis of the hydrocarbon fuel is not completed, the flue gas from the gas turbine engine 3 may contain residual carbon dioxide generated by combustion of the residual hydrocarbon species, e.g. methane. In such case, the flue gas can be diverted to the carbon dioxide capture unit 29 for improved carbon capture. This is pictorially represented by a dashed connection line 52 which fluidly couples the stack 50 to the carbon dioxide capture unit 29.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A power generation system comprising:
a pyrolysis unit comprising a pyrolysis reactor adapted to generate hydrogen from pyrolysis of hydrocarbon, in particular natural gas, and a heat generator adapted to provide heat to the pyrolysis reactor;
an internal combustion engine adapted to be supplied with hydrogen generated by the pyrolysis unit; and,
a waste heat recovery arrangement, adapted to recover waste heat from flue gas discharged by the internal combustion engine, and deliver recovered waste heat to the pyrolysis unit.

2. The power generation system of claim 1, wherein the internal combustion engine includes a gas turbine engine.

3. power generation system of claim 1, wherein the waste heat recovery arrangement comprises a first heat exchanger adapted to transfer waste heat from the flue gas to a hydrocarbon stream supplied to the pyrolysis reactor.

4. The power generation system of claim 1, wherein the waste heat recovery arrangement is adapted to supply waste heat to the heat generator.

5. The power generation system of claim 1, wherein the heat generator comprises a furnace adapted to generate heat for the pyrolysis reactor by combustion of a fuel.

6. The power generator system of claim 5, wherein the fuel comprises a hydrocarbon, preferably natural gas.

7. The power generation system of claim 5, wherein the waste heat recovery arrangement comprises a flue gas supply line, adapted to supply oxygen-containing flue gas from the internal combustion engine to the furnace.

8. The power generation system of claim 5, wherein the waste heat recovery arrangement comprises a second heat exchanger adapted to transfer waste heat from the flue gas to an oxidant stream supplied to the furnace.

9. The power generation system of claim 8, when depending upon at least claim 2, wherein the first heat exchanger and the second heat exchanger are arranged in series along a flue gas discharge path.

10. The power generation system of claim 9, wherein the second heat exchanger is arranged downstream of the first heat exchanger with respect to a direction of flow of the flue gas in the flue gas discharge path.

11. The power generation system of claim 8, wherein the first heat exchanger and the second heat exchanger are arranged in parallel, and are adapted to process each a portion of a total flue gas flowrate.

12. The power generation system of claim 8, wherein the oxidant stream is an oxygen stream.

13. The power generation system of claim 5, further comprising a carbon dioxide capture unit adapted to receive exhaust gas from the furnace and capture carbon dioxide therefrom.

14. The power generation system of claim 1, comprising a bottom thermodynamic cycle, adapted to convert waste heat from the flue gas into mechanical power.

15. The power generation system of claim 13, wherein the bottom thermodynamic cycle is adapted to recover waste heat downstream of the waste heat recovery arrangement, at a temperature lower than a temperature of waste heat supplied to the pyrolysis unit.

16. The power generation system of claim 15, wherein the bottom thermodynamic cycle has a process fluid heater adapted to remove waste heat from the flue gas at a temperature lower than a temperature at which waste heat is delivered to the pyrolysis unit.

17. The power generation system of claim 16, comprising a main flue-gas flow path extending from the internal combustion engine to the heat generator; wherein the first heat exchanger is arranged along the flue-gas flow path; and
wherein downstream of the first heat exchanger a secondary flue-gas flow path diverts from the main flue-gas flow path, the secondary flue-gas flow path being adapted to deliver a portion of the flue gas flowrate to the bottom thermodynamic cycle.

18. The power generation system of claim 16, comprising a flue-gas flow path extending from the internal combustion engine through the first heat exchanger and the second heat exchanger, and wherein downstream of the second heat exchanger the flue-gas flow path extends through the process fluid heater to transfer low-temperature waste heat to the bottom thermodynamic cycle.

19. A power generation method, comprising the following steps:
processing a stream of hydrocarbon in a pyrolysis unit and generating hydrogen and solid carbon therefrom;
wherein the pyrolysis unit comprises a pyrolysis reactor and a heat generator;
fueling an internal combustion engine with said hydrogen and generating mechanical power therewith;
recovering waste heat from flue gas discharged by the internal combustion engine; and
suppling recovered waste heat to the pyrolysis unit.

20. The power generation method of claim 19, wherein the internal combustion engine is a gas turbine engine.

21. The power generation method of claim 19, wherein the step of supplying recovered waste heat to the pyrolysis unit comprises the step of pre-heating the stream of hydrocarbon supplied to said pyrolysis reactor by heat exchange with said flue gas.

22. The power generation method of claim 19, wherein the step of supplying recovered waste heat to the pyrolysis unit comprises the step of supplying recovered waste heat to the heat generator.

23. The power generation method of claim 22, wherein the heat generator comprises a furnace; and further comprising the step of generating heat by combustion of fuel and an oxidant in the furnace.

24. The power generation method of claim 23, wherein the step of supplying recovered waste heat to the heat generator comprises the step of supplying oxygen-containing flue gas as oxidant to the furnace.

25. The power generation method of claim 23, wherein the step of supplying recovered waste heat to the heat generator comprises the step of pre-heating an oxidant supplied to the furnace by heat exchange with the flue gas.

26. The power generation method of claim 25, when depending at least upon claim 21, wherein the step of pre-heating the stream of hydrocarbon is performed at a flue gas temperature higher than the step of pre-heating the oxidant.

27. The power generation method of claim 23, further comprising the step of capturing carbon dioxide from combustion gas of the furnace.

28. The power generation method of claim 19, further comprising the step of suppling waste heat from the flue gas to a bottom thermodynamic cycle.

29. The power generation method of claim 28, wherein the waste heat supplied to the bottom thermodynamic cycle is at a temperature lower than the temperature of recovered waste heat supplied to the pyrolysis unit.
